(19) United States
(12) Patent Application Publication
(10) Pub. No.: US 2020/0310635 A1
(43) Pub. Date: Oct. 1, 2020

(54) DISPLAY APPARATUS FOR DISPLAYING SCROLL BAR INCLUDING BODY AND KNOB

(71) Applicant: KYOCERA Document Solutions Inc., Osaka (JP)

(72) Inventor: Keita MIYAMOTO, Osaka (JP)

(73) Assignee: KYOCERA Document Solutions Inc., Osaka (JP)

(21) Appl. No.: 16/814,561

(22) Filed: Mar. 10, 2020

(30) Foreign Application Priority Data
Mar. 26, 2019 (JP) 2019-058807
Mar. 26, 2019 (JP) 2019-058808

(51) Int. Cl. G06F 3/0485; G06F 3/0488; G06F 3/0484

(52) U.S. Cl. CPC G06F 3/04855; G06F 3/04842; G06F 3/04847; G06F 3/04883

(57) ABSTRACT

A display apparatus includes a display device, a touch panel, and a control device. The control device includes a processor and functions, through the processor executing a control program, as a controller that allows the display device to display a scroll bar, on a screen of the display device, including: a body extending along a predetermined direction; and a knob disposed within the body.

### INCORPORATION BY REFERENCE

This application claims priority to Japanese Patent Application No. 2019-058807 filed on 26 Mar. 2019 and No. 2019-058808 filed on 26 Mar. 2019, the entire contents of which are incorporated by reference herein.

### BACKGROUND

The present disclosure relates to display apparatuses and particularly relates to a technique for displaying a scroll bar.

A technique is known for displaying a slide bar or scroll bar including a knob and accepting an instruction according to a user's operation made on the slide bar or scroll bar.

For example, there is known a touch input determination device in which a slide bar including a bar extending in a first direction and a knob is displayed in a location of a touch panel where a pinch-in gesture has been made and, upon subsequent dragging in the first direction on the knob, the knob is displaced in response to the drag gesture and a floor where an elevator stops is selected according to the amount of displacement of the knob.

For another example, there is known a portable device in which, upon detection of a touch on a knob icon within a scroll bar, the scroll bar is enlarged in order to enable the control of the scrubbing speed.

For still another example, there is known an image editor in which, upon user's touch on a scroll button as a knob displayed on a touch panel display, a scroll bar and the scroll button are enlarged.

There is also known a display control device in which a scroll bar is displayed in a location of a display where a user touches and, upon subsequent user's touch on a point within the region of the scroll bar and away from a knob, the knob is displaced to the point of touch in the scroll bar.

### SUMMARY

A technique improved over the aforementioned techniques is proposed as one aspect of the present invention.

A display apparatus according to an aspect of the present disclosure includes a display device, a touch panel, and a control device. The control device includes a processor and functions, through the processor executing a control program, as a controller that allows the display device to display a scroll bar, on a screen of the display device, including: a body extending along a predetermined direction; and a knob disposed within the body.

### BRIEF DESCRIPTION OF THE DRAWINGS

FIG. 1 is a block diagram showing an internal configuration of a display apparatus according to a first embodiment of the present disclosure.

FIG. 2 is a view showing an example of a display screen.

FIG. 3 is a flowchart showing scroll bar displacement processing according to the first embodiment of the present disclosure.

FIG. 4 is a view showing examples of a first touch gesture and a second touch gesture.

FIG. 5 is a view showing an example of a display screen when the scroll bar is displaced.

FIG. 6 is a view showing an example of a touch gesture on a body region.

FIG. 7 is a view showing an example of a display screen when an electronic book image is scrolled in response to the touch gesture on the body region.

FIG. 8A is a portion of a flowchart showing scroll cancellation processing according to a second embodiment of the present disclosure.

FIG. 8B is the remaining portion of the flowchart showing the scroll cancellation processing according to the second embodiment of the present disclosure.

FIG. 9 is a view showing an example of a display screen when a slide gesture is made.

FIG. 10 is a view showing an example of a display screen when the knob is moved from a second display location to a first display location.

### DETAILED DESCRIPTION

### First Embodiment

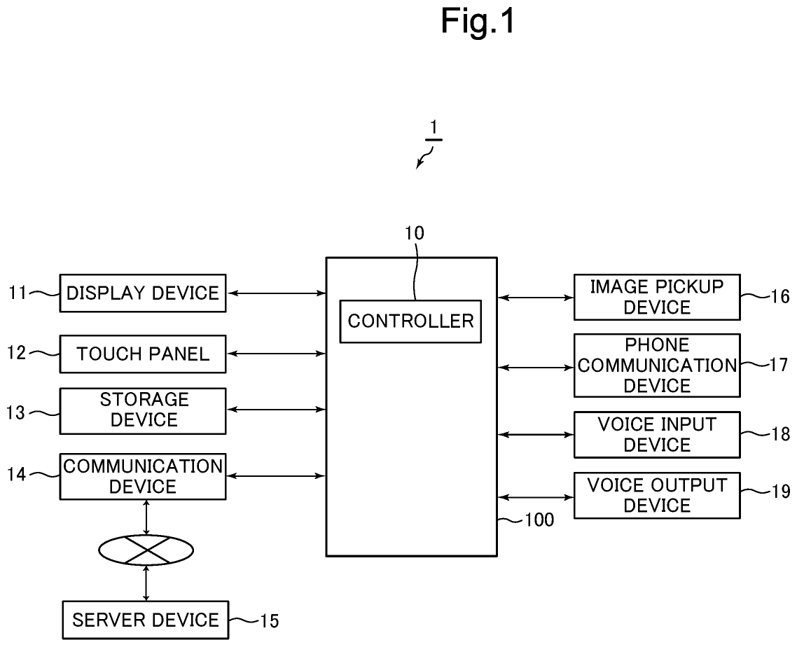

Hereinafter, a description will be given of a display apparatus according to a first embodiment of the present disclosure, with reference to the drawings. FIG. 1 is a block diagram showing an internal configuration of the display apparatus according to the first embodiment of the present disclosure. Referring to FIG. 1, the display apparatus 1 is, for example, a smartphone. The display apparatus 1 includes a control device 100, a display device 11, a touch panel 12, a storage device 13, a communication device 14, an image pickup device 16, a phone communication device 17, a voice input device 18, and a voice output device 19.

The control device 100 includes a processor, a RAM (random access memory), and so on. The processor is, for example, a CPU (central processing unit), an MPU (micro processing unit) or an ASIC (application specific integrated circuit). The control device 100 functions as a controller 10 when a control program stored in the storage device 13 is executed by the above-mentioned processor.

The controller 10 governs the overall operation control of the display apparatus 1. Specifically, the controller 10 controls the respective operations of components of the display apparatus 1 and communication with a server device 15 or the like connected thereto via a network. However, the controller 10 may not be implemented by the operation in accordance with the control program, but may instead be configured operably by a hardware circuit.

The control device 100 is connected electrically to the display device 11, the touch panel 12, the storage device 13, the communication device 14, the image pickup device 16, the phone communication device 17, the voice input device 18, the voice output device 19, and so on.

The display device 11 is a display device formed of a liquid crystal display, an organic EL (an organic light-emitting diode) display or the like. The display device 11 displays various screens related to various functions executable by the display apparatus 1.

The touch panel 12 is disposed to cover the display device 11. The touch panel 12 detects a touch gesture with a user's finger, together with a point of the touch gesture. The user inputs through the touch panel 12 various pieces of information including instructions for various functions executable by the display apparatus 1.

The storage device 13 is a large storage device, such as a flash memory. The storage device 13 holds various control programs for implementing general operations of the display apparatus 1. The storage device 13 holds as one of the above various control programs a first control program for executing scroll bar displacement processing according to the first embodiment of the present disclosure.

The storage device 13 stores a plurality of electronic files (hereinafter, referred to as “electronic book files”) each recording the contents of a book formed of a plurality of pages. The controller 10 downloads an electronic book file through the communication device 14 from the server device 15 or the like, which is capable of providing electronic book files, in response to a user's instruction input through the touch panel 12 to acquire the electronic book file, and allows the storage device 13 to store the electronic book file.

The communication device 14 includes a communication module. The display apparatus 1 performs data communication through the communication device 14 with the server device 15 or the like on the network.

The image pickup device 16 is a digital camera composed of an image pickup element, a lens, and so on.

The phone communication device 17 performs connection with a public line and transmits and receives voice data over the public line.

The voice input device 18 includes a microphone, an A/D converter circuit capable of converting an analog signal based on voice input to the microphone to a digital signal, and so on.

The voice output device 19 includes a D/A converter circuit capable of converting a digital signal represented by voice data to an analog signal, a speaker capable of outputting voice based on the analog signal, an amplifier, and so on.

A power source is connected to each of the components of the display apparatus 1. Each component of the display apparatus 1 operates with power supplied from the power source.

[Operations]

A description will be given below of operations of the display apparatus 1 according to the first embodiment of the present disclosure. In the following description, the term “slide gesture” refers to a gesture that the user touches an image being displayed on the display device 11 with their finger and moves the finger to a point of destination while touching the image with the finger. Hereinafter, the point of destination of the slide gesture is referred to as a slide point.

The following description is based on an assumption that the display apparatus 1 is powered on. Suppose that the user specifies through the touch panel 12 one of the plurality of electronic book files stored in the storage device 13 and inputs an electronic book display instruction to allow the display device 11 to display an image of an electronic book (an electronic book image) based on the specified electronic book file. When accepting the above electronic book display instruction through the touch panel 12, the controller 10 allows the display device 11 to display a display screen for displaying an electronic book image.

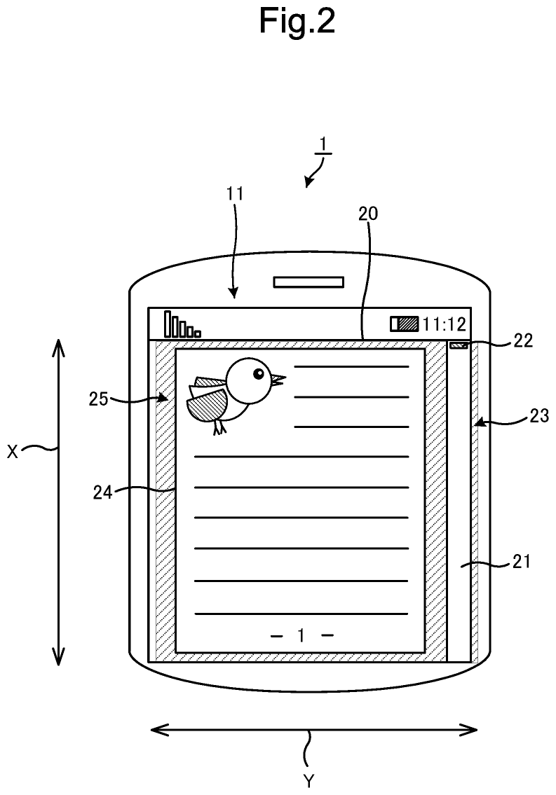

FIG. 2 is a view showing an example of the display screen. Referring to FIG. 2, the controller 10 allows the display device 11 to display, in a predetermined first location within the display screen 20, a scroll bar 23 including: a body 21 extending along a predetermined first direction X; and a knob 22 disposed within the body 21. No particular limitation is placed on the first location so long as it is a location where the scroll bar 23 should commonly be displayed. In this embodiment, one end of the display screen 20 in a second direction Y perpendicular to the first direction X is predetermined as the first location. The controller 10 also allows the display device 11 to display, in a portion of the display screen 20 other than the scroll bar 23, a display region 25 where a targeted electronic book image 24 is to be displayed.

For example, suppose that the electronic book image 24 contains 100 pages of images aligned in the first direction X. In this case, the controller 10 does not enable the display of the entire electronic book image 24 within the display region 25 at a time. Therefore, the controller 10 allows, of the entire electronic book image 24, only a portion (hereinafter, referred to as a “display portion”) displayable within the display region 25 to be displayed in the display region 25. For example, suppose that the display portion is an image on one page of the electronic book image 24. In this embodiment, the controller 10 allows the display device 11 to display as the display portion an image on the first page of the electronic book image 24.

The controller 10 equalizes the ratio of the length of the above display portion in the first direction X to the entire length of the electronic book image 24 in the first direction X with the ratio of the length of the knob 22 in the first direction X to the length of the body 21 in the first direction X. The controller 10 makes the location of the knob 22 in the body 21 in the first direction X correspond to the location of the above display portion in the entire electronic book image 24 in the first direction X. In this case, the location of the knob 22 in the body 21 corresponds to the location of the image on the first page in the electronic book image 24.

The controller 10 scrolls the electronic book image 24 in the first direction X according to a slide gesture on the knob 22 in the first direction X or a touch gesture on a region of the body 21 (hereinafter, referred to as a body region) other than the present location of the knob 22, which is a gesture having been input through the touch panel 12 by the user, thus enabling a page change of the electronic book image 24 and the display of the changed page in the display region 25.

(Scroll Bar Displacement Processing)

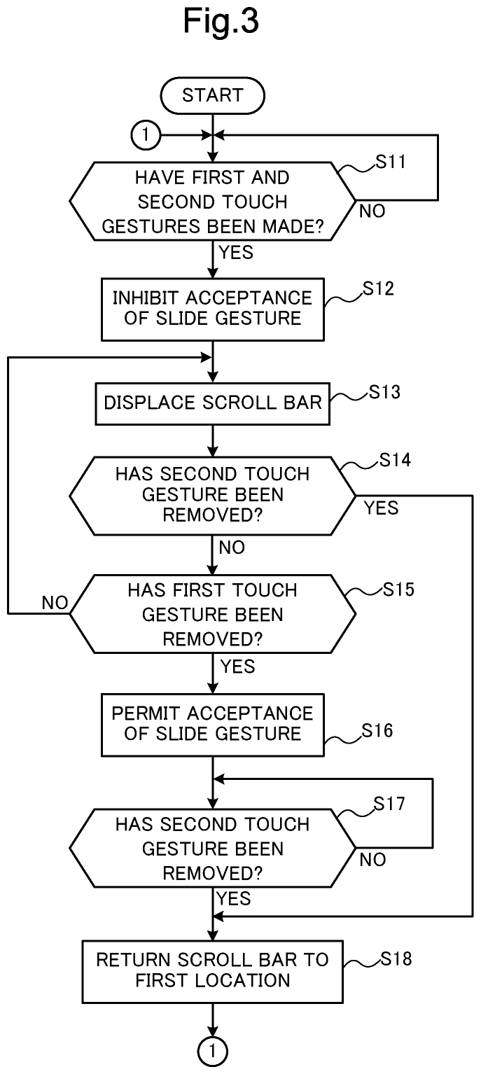

FIG. 3 is a flowchart showing scroll bar displacement processing according to the first embodiment of the present disclosure. Referring to FIG. 3, when the display screen 20 is displayed on the display device 11, the controller 10 starts executing scroll bar displacement processing. When starting the scroll bar displacement processing, the controller 10 waits until it accepts through the touch panel 12 a first touch gesture on the display region 25 and a second touch gesture on the body region at the same period of time (NO in step S11). The term “the same period of time” herein refers to the same moment or a predetermined period of time from the acceptance of one of the touch gestures to the lapse of a predetermined time.

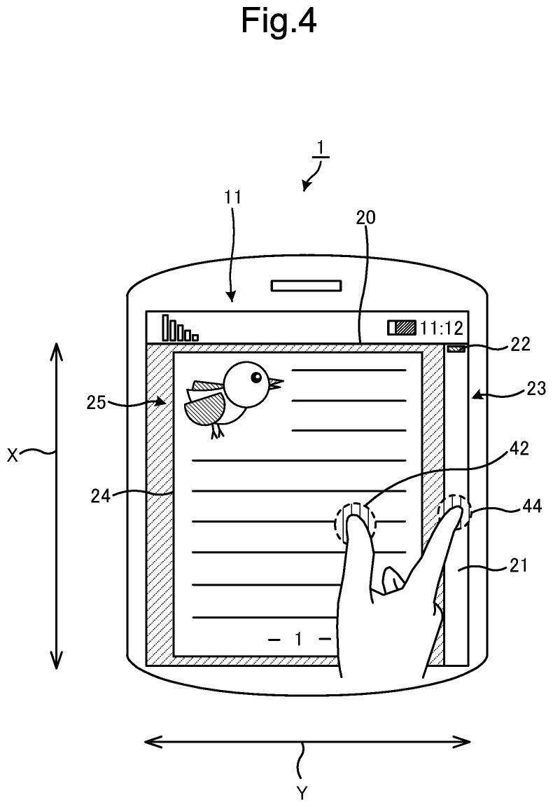

FIG. 4 is a view showing examples of the first touch gesture and the second touch gesture. Referring to FIG. 4, suppose that the user touches an arbitrary portion 24 within the display region 25 with their thumb and touches an arbitrary portion 44 within the body region with their index finger. When the touch panel 12 detects the above two touch gestures at the same period of time, the controller 10 determines that it has accepted the first touch gesture and the second touch gesture at the same period of time (YES in step S11) and inhibits the acceptance of a slide gesture on the knob 22 in the first direction X (step S12).

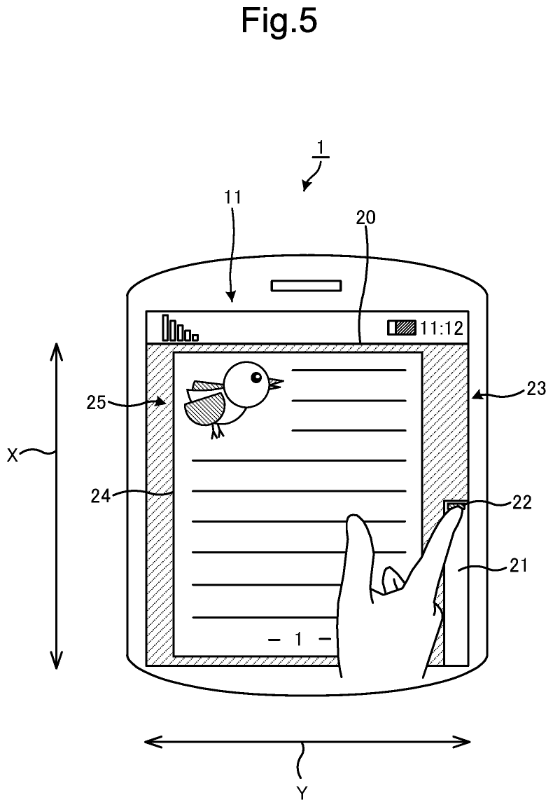

After the inhibition of the acceptance of a slide gesture, the controller 10 allows the display device 11 to displace the scroll bar 23 from the first location so that the knob 22 is displayed at a second location where the second touch gesture has been made (step S13). FIG. 5 is a view showing an example of a display screen when the scroll bar is displaced. In the example shown in FIG. 5, the second location is a location corresponding to the portion 44 shown in FIG. 4. After the displacement of the scroll bar 23, the controller 10 determines whether or not the second touch gesture has been removed (step S14).

(1) Case where Second Touch Gesture is Removed

Suppose that after the displacement of the scroll bar 23 in step S13, the user does not desire to scroll the electronic book image 24 and releases their index finger from the portion 44. When the second touch gesture becomes undetected by the touch panel 12, the controller 10 determines that the second touch gesture has been removed (YES in step S14), and moves the scroll bar 23 back to the first location (step S18). After the return of the scroll bar 23 to the first location, the controller 10 returns the processing to step S11.

(2) Case where Only First Touch Gesture is Removed

Suppose that after the displacement of the scroll bar 23 in step S13, the user releases their thumb from the portion 42 while keeping the touch on the portion 44 with their index finger. When the first touch gesture becomes undetected by the touch panel 12 and only the second touch gesture is detected, the controller first determines that the second touch gesture has not been removed (NO in step S14), then determines that the first touch gesture has been removed (YES in step S15), and permits the acceptance of a slide gesture on the knob 22 (step S16). After the permission of the acceptance of a slide gesture, the controller 10 waits until the second touch gesture is removed (NO in step S17).

Suppose that, in this state, the user makes a slide gesture on the knob 22 in the first direction X in order that an image on a desired page of the electronic book image 24 is displayed in the display region 25. In this case, when the above slide gesture is detected by the touch panel 12, the controller 10 displaces the knob 22 until the knob 22 is displayed at a slide point, and scrolls the electronic book image 24 in the first direction X until a display portion of the electronic book image 24 corresponding to the location of the displaced knob 22 is displayed in the display region 25.

Suppose that when the desired page is displayed in the display region 25 by the scroll of the electronic book image 24, the user releases their index finger from the portion 44. When the second touch gesture becomes undetected by the touch panel 12, the controller 10 determines that the second touch gesture has been removed (YES in step S17), and moves the scroll bar 23 back to the first location (step S18). After the return of the scroll bar 23 to the first location, the controller 10 returns the processing to step S11.

While after the displacement of the scroll bar 23 in step S13 the first touch gesture and the second touch gesture are held, the controller 10 determines that the second touch gesture has not been removed (NO in step S14), determines that the first touch gesture has not been removed (NO in step S15), and repeats the processing step in step S13.

Since, as described previously, the electronic book image 24 contains 100 pages of images, the length of the knob 22 in the first direction X is one-hundredth the length of the body 21 in the first direction X. As can be seen from this, if in the general technique described previously the amount of information corresponding to the length of the scroll bar 23 is large, the length of the knob 22 is very short relative to the length of the scroll bar 23. Therefore, the area of the knob 22 displayed on the display device 11 is very small relative to the area of the user's finger. In this case, it is difficult for the user to make a touch gesture directly on the knob 22.

In the first embodiment, the controller 10 allows the display device 11 to display, in a predetermined first location, a scroll bar 23 including: a body 21 extending along the first direction X; and a knob 22 disposed within the body 21. When accepting, through the touch panel 12, a first touch gesture on the display region 25 and a second touch gesture on the body region at the same period of time, the controller 10 allows the display device 11 to displace the scroll bar 23 from the first location so that the knob 22 is displayed at a second location where the second touch gesture has been made.

By making the first touch gesture and the second touch gesture in the above manner, the user can select the knob 22, without the need to recognize the present location of the knob 22 being displayed, move their finger to the location of the knob 22, and make a touch gesture directly on the knob 22. Therefore, even if the area of the knob 22 displayed is small, the user can easily make a touch gesture on the knob 22.

Furthermore, in the first embodiment, when the controller 10 accepts through the touch panel 12 the first touch gesture and the second touch gesture at the same period of time and the second touch gesture is then removed, the controller 10 allows the display device 11 to move the scroll bar 23 back to the first location. Thus, the user can easily return the scroll bar 23 to the original location and redisplay it in the original location.

Moreover, in the first embodiment, when accepting through the touch panel 12 the first touch gesture and the second touch gesture at the same period of time, the controller 10 inhibits the acceptance of a slide gesture on the knob 22 in the first direction X through the touch panel 12. When the controller 10 accepts through the touch panel 12 the first touch gesture and the second touch gesture at the same period of time and only the first touch gesture is then removed, the controller 10 permits the acceptance of the above slide gesture. Thus, it can be prevented that despite the user has not yet selected the knob, a slide gesture on the knob is accidentally accepted.

In the first embodiment, the controller 10 allows the display device 11 to display, together with the scroll bar 23, a portion of the electronic book image 24 in the display region 25 which is a region of the display screen 20 other than the scroll bar 23. The controller 10 allows the scroll bar 23 to be displayed so that, in terms of length in the first direction X, the ratio of the length of the display portion to the length of the electronic book image 24 is equal to the ratio of the length of the knob 22 to the length of the body 21 and, in terms of location in the first direction X, the location of the knob 22 in the body 21 corresponds to the location of the display portion in the electronic book image 24.

Furthermore, when accepting through the touch panel 12 a slide gesture on the knob 22 in the first direction X, the controller 10 allows the display device 11 to displace the knob 22 until the knob 22 is displayed at the slide point and scroll the electronic book image 24 in the first direction X until a portion of the electronic book image 24 corresponding to the location of the displaced knob 22 is displayed in the display region 25. Thus, the user can easily display a desired image by a slide gesture on the knob 22.

### Second Embodiment

Hereinafter, a description will be given of a display apparatus according to a second embodiment of the present disclosure, with reference to the drawings. The display apparatus 1 according to the second embodiment of the present disclosure has the same configuration as the display apparatus 1 according to the first embodiment, except that the controller 10 has a time counter function and the storage device 13 holds a second control program. Different points from the first embodiment will be described below.

The controller 10 has a general time counter function. The controller 10 uses the time counter function to count the elapsed period of time from a predetermined moment by seconds.

The storage device 13 holds as one of the above various control programs a second control program for executing scroll cancellation processing according to the second embodiment of the present disclosure.

[Operations]

A description will be given below of operations of the display apparatus 1 according to the second embodiment of the present disclosure. Hereinafter, the first point of touch of the user's finger to an image during a slide gesture is referred to as a start point of the slide gesture. The point of release of the user's finger from the image after the slide gesture is referred to as an end point of the slide gesture. Examples of the slide gesture include a flick gesture and a drag gesture.

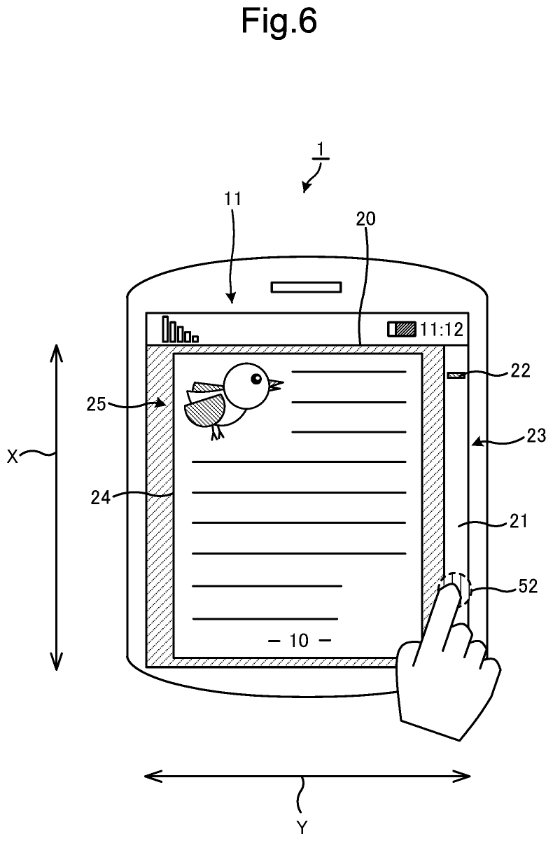

The following description is based on an assumption that the display apparatus 1 is powered on. Suppose that the user inputs through the touch panel 12 an electronic book display instruction in the same manner as described in the first embodiment. When accepting the above electronic book display instruction through the touch panel 12, the controller 10 allows the display device 11 to display a display screen 20 for displaying an electronic book image as shown in FIG. 2. In the example shown in FIG. 6, the controller 10 allows the display device 11 to display as the display portion an image on the tenth page of the electronic book image 24. The location of the knob 22 in the body 21 corresponds to the location of the image on the tenth page in the electronic book image 24.

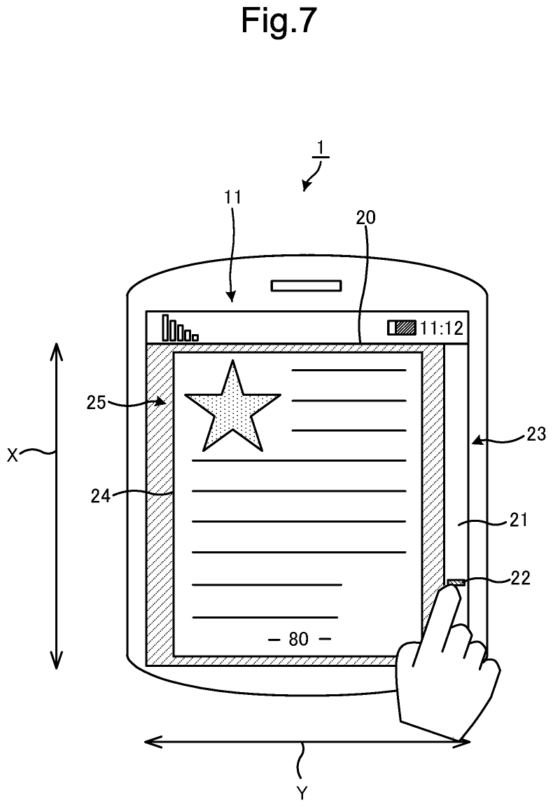

FIG. 6 is a view showing an example of a touch gesture on the body region. FIG. 7 is a view showing an example of a display screen when the electronic book image is scrolled in response to the touch gesture on the body region. Referring to FIG. 6, suppose that the user has accidentally touched a portion 52 of the body region. Referring to FIG. 7, when accepting a touch gesture on the portion 52 through the touch panel 12, the controller 10 allows the display device 11 to displace the knob 22 from a location of the knob 22 displayed until the moment of acceptance of the touch gesture (hereinafter, referred to as a “first display location”) to a location corresponding to the portion 52 (hereinafter, referred to as a “second display location”) along the first direction X.

Simultaneously with allowing the display device 11 to displace the knob 22 from the first display location to the second display location, the controller 10 allows the display device 11 to scroll the electronic book image 24 along the first direction X until a display portion of the electronic book image 24 corresponding to the second display location is displayed in the display region 25. In the example shown in FIG. 7, at the end of the scroll, the controller 10 allows an image on the 80th page of the electronic book image 24 to be displayed as the display portion corresponding to the second display location in the display region 25.

(Scroll Cancellation Processing)

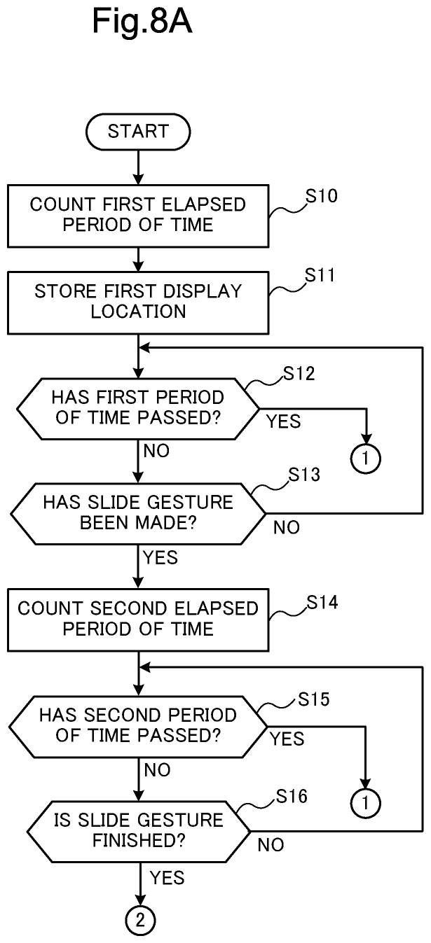

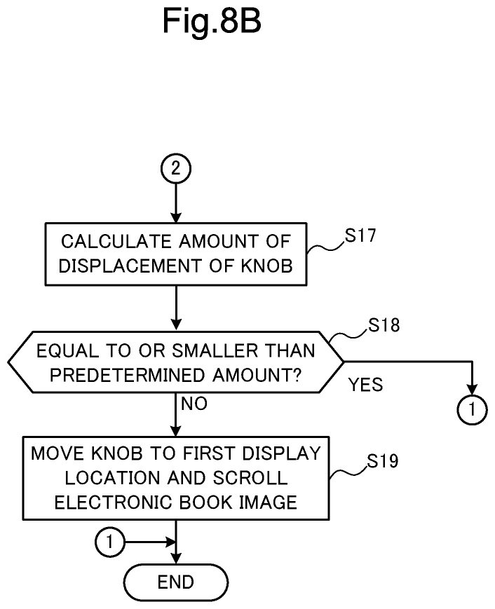

FIGS. 8A and 8B show a flowchart showing scroll cancellation processing according to the second embodiment of the present disclosure. When accepting the touch gesture on the portion 52 through the touch panel 12, the controller 10 starts executing scroll cancellation processing in conjunction with the displacement of the knob 22 from the first display location to the second display location and the scroll of the electronic book image 24.

Referring to FIG. 8A, in the scroll cancellation processing, the controller 10 uses the time counter function to start counting the elapsed period of time from the moment of acceptance of the touch gesture (hereinafter, referred to as a “first elapsed period of time”) (step S10). After the start of counting of the first elapsed period of time, the controller 10 allows the storage device 13 to store coordinate information indicating the first display location (step S11).

After the storage of the first display location, the controller 10 determines whether or not a predetermined period of time (hereinafter, referred to as a “first period of time”) has passed since the moment of acceptance of the touch gesture (step S12). In this embodiment, the predetermined first period of time is “10 seconds”. When determining that the first period of time has not passed (NO in step S12), the controller 10 determines whether or not a slide gesture starting from the portion 52 has been accepted through the touch panel 12 (step S13). When determining that the slide gesture has not been accepted (NO in S13), the controller 10 returns the processing to step S12.

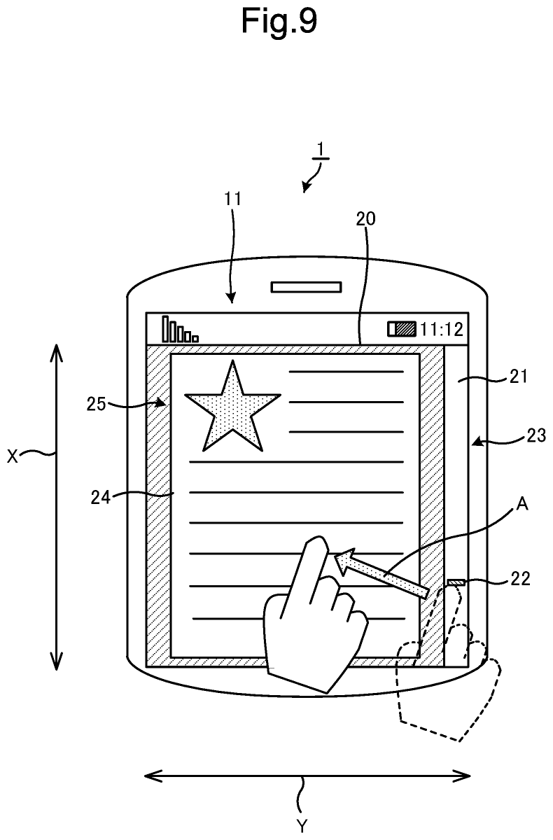

FIG. 9 is a view showing an example of a display screen when a slide gesture is made. Referring to FIG. 9, suppose that under the above circumstances the user becomes aware that an unintended scroll of the electronic book image 24 is being performed and makes as a slide gesture a flick gesture in a third direction A from the portion 52 toward the center of the display screen 20 three seconds after the touch gesture.

When accepting the above flick gesture through the touch panel 12, the controller 10 determines that the first period of time has not passed (NO in step S12), then determines that a slide gesture starting from the portion 52 has been accepted (YES in step S13), and uses the time counter function to start counting the elapsed period of time from the moment of acceptance of the start of the slide gesture, i.e., the moment of detection of the start point of the slide gesture by the touch panel 12 (hereinafter, referred to as a “second elapsed period of time”) (step S14). On the other hand, when the first period of time has passed without the above slide gesture by the user, the controller 10 determines that the first period of time has passed (YES in step S12), and ends the scroll cancellation processing.

After the start of counting of the second elapsed period of time, the controller 10 determines whether or not a predetermined period of time (hereinafter, referred to as a “second period of time”) has passed since the moment of acceptance of the start of the slide gesture (step S15). In this embodiment, the predetermined second period of time is “5 seconds”. When determining that the second period of time has not passed (NO in step S15), the controller 10 determines whether or not the end of the slide gesture starting from the portion 52 has been accepted through the touch panel 12 (step S16). In this embodiment, suppose that when the touch panel 12 detects an end point of the slide gesture, the controller 10 determines that the end of the slide gesture has been accepted. When determining that the end of the slide gesture has not been accepted (NO in S16), the controller 10 returns the processing to step S15.

In this case, since the user has made a flick gesture, the controller 10 determines that the second period of time has not passed (NO in step S15), determines that the end of the slide gesture has been accepted (YES in step S16), and calculates the amount of displacement of the knob 22 indicating the distance from the first display location to the second display location as shown in FIG. 8B (step S17). On the other hand, when the second period of time has passed without release of the user's finger from the portion 52 after the above slide gesture, the controller 10 determines that the second period of time has passed (YES in step S15), and ends the scroll cancellation processing.

In this embodiment, suppose that the controller 10 calculates, as the amount of displacement of the knob 22 indicating the distance from the first display location to the second display location, the ratio of the length of displacement of the knob 22 in the first direction X to the length of the body 21 in the first direction X. Specifically, the controller 10 first calculates the length from the first display location to the second display location. The controller 10 divides the calculated length by the length of the body 21 in the first direction X to calculate the above ratio. In this case, suppose that a value of “0.7” is calculated as the above ratio.

After the calculation of the amount of displacement of the knob 22, the controller 10 determines whether or not the calculated amount of displacement is equal to or smaller than a predetermined value (step S18). In this embodiment, a value of “0.1” is predetermined. Since the calculated amount of displacement is “0.7”, the controller 10 determines that the calculated amount of displacement of the knob 22 is neither equal to nor smaller than the predetermined value (NO in step S18), allows the display device 11 to move the knob 22 from the second display location to the first display location along the first direction X based on the coordinate information stored in the storage device 13 and indicating the first display location, and allows the display device 11 to scroll the electronic book image 24 along the first direction X until the display portion of the electronic book image 24 corresponding to the first display location is displayed (step S19).

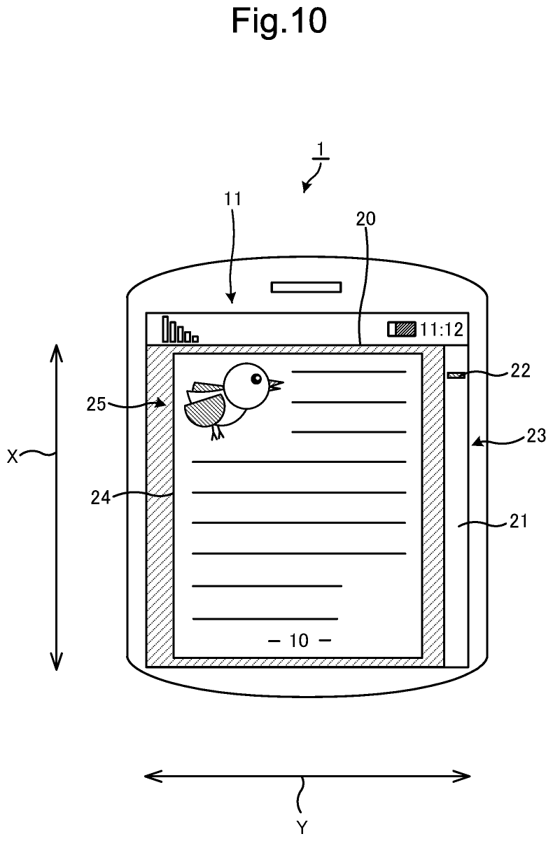

FIG. 10 is a view showing an example of a display screen when the knob is moved from the second display location to the first display location. Referring to FIG. 10, when the above movement of the knob 22 from the second display location to the first display location is finished, the controller 10 allows the display device 11 to display the knob 22 at the first display location where the knob 22 was displayed until the moment of acceptance of the touch gesture. Furthermore, when the above scroll of the electronic book image 24 is finished, the controller 10 allows an image on the tenth page of the electronic book image 24 to be displayed as the display portion corresponding to the first display location in the display region 25. In this manner, the controller 10 allows the display device 11 to return the display of the display device 10 to a state before the scroll is implemented. On the other hand, in the case of ending the scroll cancellation processing without executing the processing step in step S19, the controller 10 keeps the display device 11 from returning the display of the display device 11 to a state before the scroll is implemented.

After the processing step in step S19, the controller 10 ends the scroll cancellation processing. On the other hand, if the calculated amount of displacement is, for example, a value of “0.08”, the controller 10 determines that the calculated amount of displacement is smaller than the predetermined value (YES in step S18), and ends the scroll cancellation processing.

As thus far described, the user may accidentally touch the body region, so that a scroll of the electronic book image 24 not intended by the user may be implemented. Particularly, if the location of the knob 22 having been displayed until just before a touch gesture is made is significantly distant from the point where the touch gesture has been made, the amount of scroll of the electronic book image 24 becomes large, which is user-unfriendly because the user cannot recognize a display portion of the electronic book image 24 having been displayed until just before the touch gesture is made.

In the general technique described previously, nothing is done but to move the knob according to a drag gesture or a touch gesture, which cannot solve the above problem.

In the second embodiment, the controller 10 allows the display device 11 to display, together with a scroll bar 23 including a body 21 extending along the first direction X and a knob 22 disposed within the body 21, a portion of the electronic book image 24 as a display portion in the display region 25. The controller 10 allows the scroll bar 23 to be displayed so that the location of the knob 22 in the body 21 in the first direction X corresponds to the location of the display portion in the electronic book image 24 in the first direction X.

When accepting through the touch panel 12 a touch gesture on a portion 52 of the body region, the controller 10 allows the display device 11 to scroll the electronic book image 24 until a display portion thereof corresponding in the first direction X to the second display location where the touch gesture has been made is displayed in the display region 25. When, after the scroll is implemented, the controller 10 accepts through the touch panel 12 a slide gesture starting from the portion 52, the controller 10 allows the display device 11 to return the display of the display device 11 to a state before the scroll is implemented. When, after the scroll is implemented, a slide gesture starting from the portion 52 remains unaccepted by the controller 10 through the touch panel 12, the controller 10 keeps the display device 11 from returning the display of the display device 11 to a state before the scroll is implemented.

Thus, by making a slide gesture starting from the portion 52 after making a touch gesture on the portion 52, the user can return the display portion of the electronic book image 24 from a display portion corresponding to the second display location to a display portion displayed until the moment of acceptance of the touch gesture. Therefore, even if the user makes an unintended touch gesture on the scroll bar 23, the user can easily cancel the implemented scroll of the electronic book image 24.

Furthermore, by avoiding making a slide gesture starting from the portion 52 after making a touch gesture on the portion 52, the user can keep the display portion of the electronic book image 24 from being returned from a display portion corresponding to the second display location to a display portion displayed until the moment of acceptance of the touch gesture. Therefore, in the case where the user has made an intended touch gesture on the scroll bar 23, the user can prevent the implemented scroll of the electronic book image 24 from being cancelled, which increases user-friendliness.

Moreover, in the second embodiment, when accepting a slide gesture starting from a portion 52 of the body region before the first period of time has passed since the moment of acceptance of a touch gesture on the portion 52, the controller 10 allows the display device 11 to return the display of the display device 10 to a state before the scroll is implemented. When a slide gesture starting from the portion 52 remains unaccepted by the controller 10 until the first period of time has passed since the moment of acceptance of a touch gesture on the portion 52, the controller 10 keeps the display device 11 from returning the display of the display device 10 to a state before the scroll is implemented.

Thus, by making a slide gesture starting from the portion 52 before the lapse of the first period of time after making a touch gesture on the portion 52, the user can return the display portion of the electronic book image 24 from a display portion corresponding to the second display location to a display portion displayed until the moment of acceptance of the touch gesture. Furthermore, by avoiding making a slide gesture starting from the portion 52 until the lapse of the first period of time after making a touch gesture on the portion 52, the user can fix the display portion of the electronic book image 24 to a display portion corresponding to the second display location where the touch gesture has been made. Thus, the user-friendliness further increases.

In the second embodiment, when accepting the end of a slide gesture starting from the portion 52 before the second period of time has passed since the moment of acceptance of the start of the slide gesture, the controller 10 allows the display device 11 to return the display of the display device 10 to a state before the scroll is implemented. When the end of a slide gesture starting from the portion 52 remains unaccepted by the controller 10 through the touch panel 12 until the second period of time has passed since the moment of acceptance of the start of the slide gesture, the controller 10 keeps the display device 11 from returning the display of the display device 10 to a state before the scroll is implemented.

Thus, by releasing the finger from the touch panel 12 before the lapse of the second period of time after making a slide gesture starting from the portion 52, the user can return the display portion of the electronic book image 24 from a display portion corresponding to the second display location to a display portion displayed until the moment of acceptance of a touch gesture on the portion 52. Furthermore, by avoiding the release of the finger from the touch panel 12 until the lapse of the second period of time after making a slide gesture starting from the portion 52, the user can keep the display portion of the electronic book image 24 from being returned from a display portion corresponding to the second display location to a display portion displayed until the moment of acceptance of a touch gesture on the portion 52. Thus, the user-friendliness further increases.

In the second embodiment, when accepting a touch gesture on a portion 52 of the body region, the controller 10 allows the display device 11 to perform a scroll and displace the knob 22 along the first direction X from the first display location where the knob 22 has been displayed until the moment of acceptance of the touch gesture to the second display location where the touch gesture has been made. Thus, by confirming the location of the knob 22 in the body 21, the user can easily confirm where in the electronic book image 24 the display portion after the scroll has been implemented is located.

In the second embodiment, when the amount of displacement of the knob 22 corresponding to the distance from the first display location to the second display location is larger than the predetermined value, the controller 10 allows the display device 11 to return the display of the display device 11 to a state before the scroll is implemented. When the amount of displacement of the knob 22 is equal to or smaller than the predetermined value, the controller 10 keeps the display device 11 from returning the display of the display device 10 to a state before the scroll is implemented.

Thus, when the amount of scroll of the electronic book image 24 is large, so that the user is highly likely to have difficulty in recognizing a display portion corresponding to the first display location, it is possible to return the display portion of the electronic book image 24 from a display portion corresponding to the second display location to a display portion corresponding to the first display location. On the other hand, when the user is highly likely to be able to recognize a display portion corresponding to the first display location even if a display portion corresponding to the second display location is being displayed, it is possible to keep the display portion of the electronic book image 24 from being returned from a display portion corresponding to the second display location to a display portion corresponding to the first display location. Therefore, even if the user makes an unintended touch gesture on the scroll bar 23, the user can prevent the implemented scroll from being cancelled in vain. This further increases the user-friendliness.

### Modifications of Second Embodiment

Although in the second embodiment the controller 10 calculates, as the amount of displacement of the knob 11 in step S17, the ratio of the length of displacement of the knob 22 in the first direction X to the length of the body 21 in the first direction X, the present disclosure is not limited to this mode of implementation. For example, as the amount of displacement of the knob 22 in step S17, the controller 10 may simply calculate the length from the first display location to the second display location. In this case, the controller 10 determines, in step S18, whether or not the calculated value indicating the length is equal to or smaller than a predetermined value (for example, “20” pixels).

Although in the second embodiment the controller 10 calculates the amount of displacement of the knob 22 in step S17, the present disclosure is not limited to this mode of implementation. For example, the controller 10 may calculate the amount of page movement of the electronic book image 24 in step S17. In the above second embodiment, a value of “70” pages is calculated as the amount of page movement of the electronic book image 24. In this case, the controller 10 determines, in step S18, whether or not the calculated amount of page movement is equal to or smaller than a predetermined amount (for example, “10” pages). Note that as the amount of displacement of the knob 22 increases, the amount of page movement of the electronic book image 24 also increases. On the other hand, as the amount of displacement of the knob 22 decreases, the amount of page movement of the electronic book image 24 also decreases.

Alternatively, the controller 10 may calculate the speed of the slide gesture in step S17. Specifically, the controller 10 calculates the length of the slide gesture from the start point to the end point and calculates the speed of the slide gesture based on the calculated length and the time taken for the movement of the slide gesture from the start point to the end point.

In this case, the controller 10 determines, in step S18, whether or not the calculated speed of movement of the slide gesture is equal to or lower than a predetermined speed. When the speed of the slide gesture is higher than the predetermined speed, the controller 10 allows the display device 11 to return the display of the display device 11 to a state before the scroll is implemented. When the speed of the slide gesture is equal to or lower than the predetermined speed, the controller 10 keeps the display device 11 from returning the display of the display device 10 to a state before the scroll is implemented.

Thus, by making a slide gesture starting from the portion 52 fast, the user can return the display portion of the electronic book image 24 from a display portion corresponding to the second display location to a display portion displayed until the moment of acceptance of a touch gesture on the portion 52. Furthermore, by making the slide gesture slowly, the user can keep the display portion of the electronic book image 24 from being returned from a display portion corresponding to the second display location to a display portion displayed until the moment of acceptance of the touch gesture. Therefore, even if the user makes an unintended slide gesture starting from the portion 52, the user can prevent the implemented scroll from being cancelled in vain. This further increases the user-friendliness.

Although in the second embodiment the controller 10 determines, in step S12, whether or not a slide gesture starting from the portion 52 where a touch gesture has been made has been accepted, the present disclosure is not limited to this mode of implementation. For example, in step S12, the controller 10 may determine whether or not a slide gesture starting from somewhere in the body region has been accepted. Thus, even by making a slide gesture starting from a portion of the body region other than the portion 52, the user can cancel an unintended scroll.

(Other Modifications)

The present disclosure is not limited to the configurations of the above embodiments and can be modified in various ways. For example, although in the first and second embodiments a smartphone is used as the display apparatus, it is merely illustrative and, for example, a tablet device may be used. The display apparatus according to the present disclosure may be mounted on an image forming apparatus, such as a color multifunction peripheral or black-and-white multifunction peripheral including an image forming device for forming an image on a recording medium.

The structures, configurations, and processing of the above embodiments described with reference to FIGS. 1 to 10 are merely illustrative of the present disclosure and the present disclosure is not intended to be limited to the above structures configurations, and processing.

While the present disclosure has been described in detail with reference to the embodiments thereof, it would be apparent to those skilled in the art the various changes and modifications may be made therein within the scope defined by the appended claims.

What is claimed is:

1. A display apparatus comprising:
a display device;
a touch panel; and
a control device that includes a processor and functions, through the processor executing a control program, as a controller that allows the display device to display a scroll bar, on a screen of the display device, including: a body extending along a predetermined direction; and a knob disposed within the body.

2. The display apparatus according to claim 1, wherein
the controller allows the display device to display the scroll bar in a predetermined first location, and
when accepting through the touch panel a first touch gesture on a portion of the screen other than the scroll bar and a second touch gesture on a region of the body other than the knob at the same period of time, the controller allows the display device to displace the scroll bar from the first location so that the knob is displayed at a second location where the second touch gesture has been made.

3. The display apparatus according to claim 2, wherein when the controller accepts the first touch gesture and the second touch gesture at the same period of time through the touch panel and then the second touch gesture is removed, the controller allows the display device to move the scroll bar back to the first location and display the scroll bar in the first location.

4. The display apparatus according to claim 2, wherein
when accepting the first touch gesture and the second touch gesture at the same period of time through the touch panel, the controller inhibits acceptance of a slide gesture on the knob in the predetermined direction, and
when the controller accepts the first touch gesture and the second touch gesture at the same period of time through the touch panel and then only the first touch gesture is removed, the controller permits the acceptance of the slide gesture.

5. The display apparatus according to claim 4, wherein
the controller allows the display device to display a portion of a targeted image in the portion of the screen other than the scroll bar,
the controller allows the display device to display the scroll bar so that, in terms of length in the predetermined direction, a ratio of a length of the portion of the targeted image to an entire length of the targeted image is equal to a ratio of a length of the knob to a length of the body and, in terms of location in the predetermined direction, a location of the knob in the body corresponds to a location of the portion in the targeted image, and
when accepting a slide gesture on the knob in the predetermined direction through the touch panel, the controller allows the display device to displace the knob until the knob is displayed at a destination for displacement due to the slide gesture and allows the display device to scroll the targeted image in the predetermined direction until a portion of the targeted image corresponding to the location of the knob at the destination for displacement is displayed.

6. The display apparatus according to claim 1, wherein
the controller allows the display device to display a portion of a targeted image in a portion of the screen other than the scroll bar and display the scroll bar so that a location of the knob in the body in the predetermined direction corresponds to a location of the portion in the targeted image in the predetermined direction,
when accepting a touch gesture on a region of the body other than the knob through the touch panel, the controller allows the display device to scroll the targeted image until a portion of the targeted image corresponding in the predetermined direction to a location of the body where the touch gesture has been made is displayed,
when, after the scroll is implemented, the controller accepts through the touch panel a slide gesture starting from the body, the controller allows the display device to return display of the display device to a state before the scroll is implemented, and
when, after the scroll is implemented, the slide gesture remains unaccepted by the controller through the touch panel, the controller keeps the display device from returning the display of the display device to the state before the scroll is implemented.

7. The display apparatus according to claim 6, wherein
on condition that the controller accepts the slide gesture before a predetermined first period of time has passed since a moment of acceptance of the touch gesture, the controller allows the display device to return the display of the display device to the state before the scroll is implemented, and
when the slide gesture remains unaccepted by the controller until the first period of time has passed since the moment of acceptance of the touch gesture, the controller keeps the display device from returning the display of the display device to the state before the scroll is implemented.

8. The display apparatus according to claim 7, wherein
when accepting an end of the slide gesture before a predetermined second period of time has passed since a moment of acceptance of a start of the slide gesture, the controller allows the display device to return the display of the display device to the state before the scroll is implemented, and
when the end of the slide gesture remains unaccepted by the controller until the second period of time has passed since the moment of acceptance of the start of the slide gesture, the controller keeps the display device from returning the display of the display device to the state before the scroll is implemented.

9. The display apparatus according to claim 6, wherein when accepting the touch gesture, the controller allows the display device to implement the scroll and displace the knob, along the predetermined direction, from a first display location where the knob has been displayed until a moment of acceptance of the touch gesture to a second display location where the touch gesture has been made.

10. The display apparatus according to claim 9, wherein
when a distance from the first display location to the second display location is larger than a predetermined value, the controller allows the display device to return the display of the display device to the state before the scroll is implemented, and
when the distance is equal to or smaller than the predetermined value, the controller keeps the display device from returning the display of the display device to the state before the scroll is implemented.

11. The display apparatus according to claim 6, wherein
when a speed of the slide gesture is higher than a predetermined speed, the controller allows the display device to return the display of the display device to the state before the scroll is implemented, and
when the speed of the slide gesture is equal to or lower than the predetermined speed, the controller keeps the display device from returning the display of the display device to the state before the scroll is implemented.

12. The display apparatus according to claim 10, wherein the controller calculates, as the distance from the first display location to the second display location, a ratio of a length of displacement of the knob in the predetermined direction to a length of the body in the predetermined direction.
